(19) United States
(12) Patent Application Publication
(10) Pub. No.: US 2009/0068615 A1
(43) Pub. Date: Mar. 12, 2009

(54) Method of denture fixation

(76) Inventor: Alex Aleynik, Tenafly, NJ (US)

Correspondence Address: Alex Aleynik (NYU Student), 8 Esmond Place, Tenafly, NJ, 07670, US

(21) Appl. No.: 10/613,807

(22) Filed: Sep. 11, 2007

(51) Int. Cl. A61C 13/23

(52) U.S. Cl. 433/180

(57) ABSTRACT

This method provides easy to use, non-irritating, comfortable, light, and reliable denture fixation that accurately copies the contours of the patient's gum line and holds dentures for 25-30 days.

### BACKGROUND OF THE INVENTION

The field of endeavor related to this invention is the process or method of self-applied denture adhesion.

Specific problems in the field of self-applied denture adhesion concern lack of comfort, difficulty in application, and insufficiently brief duration of hold. Denture creams like Cushion Grip are too complex to use and only provide a hold for one day. Cement adhesives are irritating to the gum line and often fail to produce an exact fit. Some cement adhesives like Airex-C manufactured by Nori Bond makes self-application by the patient very difficult. Other Denture creams like Lakalum Dentipur HAFT torte manufactured by Arkam Germany cannot create adequate prolonged fixation and easy removal during cleaning.

### BRIEF SUMMARY OF INVENTION

This invention provides a solution to the problems outlined in the background of invention, namely the problems uncomfortable hold, denture hold which fails to provide an exact fit, denture hold which is insufficiently brief, and overly complicated methods of self-applied denture fixation. This invention solves these problems by providing a comfortable, easy to use, and long lasting method of denture fixation which accurately copies the contours of the patient's gum line.

### BRIEF DESCRIPTION OF THE SEVERAL VIEWS OF THE DRAWING

FIG. 1 Top view of paper liner cut to fit the upper human gum line

FIG. 2 Top view of paper liner cut to fit the lower human gum line

FIG. 3 Top view of the upper denture plate

FIG. 4 Top view of the lower denture plate

### DETAILED DESCRIPTION OF THE INVENTION

This invention is an improved method of denture fixation. The parts necessary for the execution and understanding of my invention are as follows: 1) Denture Adhesive Cream 2) Alcohol Solvent (70% Isopropyl Alcohol Solvent works best) 3) Paper liners 4) Lower denture (denture to be applied to the lower human gum line) 5) Upper denture (denture to be applied to the upper human gum line) 6) Lower gum line closer to the human chin 7) Upper gum line farther away from the human chin than the lower human gum line.

The complete step-by-step description of my denture fixation method is as follows:

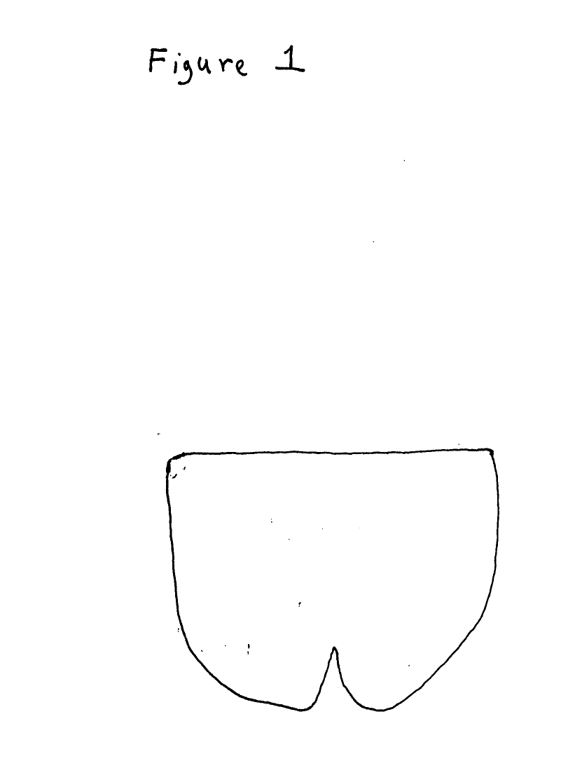

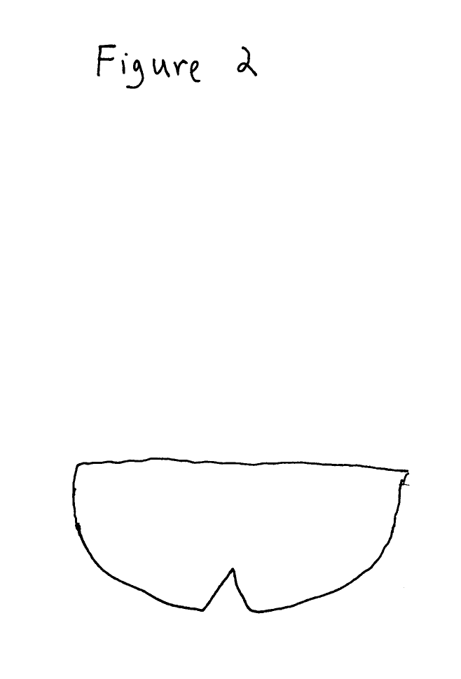

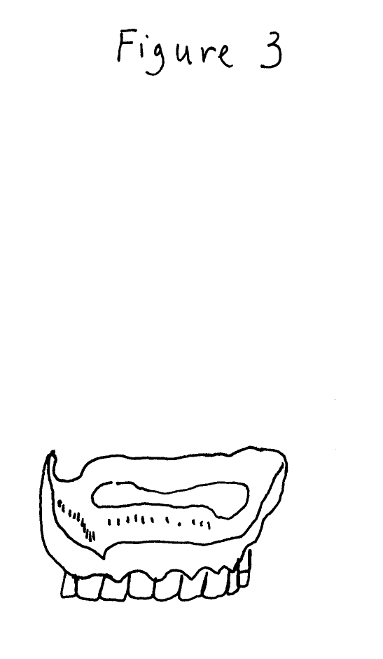

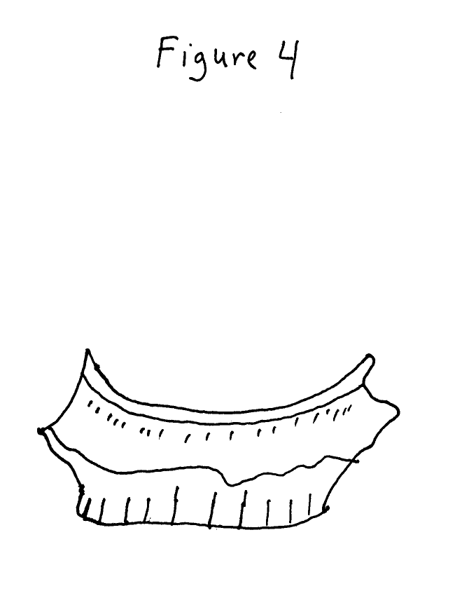

Step 1 Mix one part denture adhesive cream with one part solvent in a glass container. The mixture should be one part denture adhesive cream and one part solvent by volume. Stir thoroughly until this mixture achieves a syrup-like constituency.
Step 2 Cut paper liner to fit the upper human gum line. See FIG. 1
Step 3 Cut paper liner to fit the lower human gum line. See FIG. 2
Step 4 Apply a thin and even layer of the mixture made during Step 1 to both sides of the paper liner cut to fit the upper gum line. See FIG. 1.
Step 5 Insert the mixture coated liner from Step 4 into the plate of the upper denture. See FIG. 3.
Step 6 Mount the plate of the upper denture on the upper gum line.
Step 7 Strongly press the plate of the upper denture into the upper gum line with hands
Step 8 Bite down firmly in order to press the plate of the upper denture into the upper gum line with jaws. This will complete the seal between the upper gum line, mixture coated upper gum line liner, and the plate of the upper denture.
Step 9 Apply a thin and even layer of the mixture made during Step 1 to both sides of the paper liner cut to fit the lower gum line. See FIG. 2.
Step 10 Insert the mixture coated liner from Step 9 into the plate of the lower denture See FIG. 4.
Step 11 Mount the plate of the lower denture on the lower gum line.
Step 12 Strongly press the plate of the lower denture into the lower gum line with hands.
Step 13 Bite down firmly in order to press the plate of the lower denture into the lower gum line with jaws. This will complete the seal between the lower gum line, mixture coated lower gum line liner, and the late of the lower denture.

The specific improvements of this thirteen step method are a prolonged hold which lasts for 25-30 days and an exceptionally comfortable hold which accurately copies the contours of the patient's gum line.

What I claim as my invention is a method of denture fixation consisting of the following seven parts and the following thirteen steps:

1. The seven parts necessary for the execution and understanding of my method are listed as follows: 1) Denture Adhesive Cream 2) Solvent 3) Paper liners 4) Lower denture (denture to be applied to the lower human gum line) 5) Upper denture (denture to be applied to the upper human gum line) 6) Lower gum line closer to the human chin 7) Upper gum line farther away from the human chin than the lower human gum line.
The thirteen steps necessary for the complete step-by-step execution of my method are listed below:
Step 1 Mix one part denture adhesive cream with one part solvent in a glass container. The mixture should be one part denture adhesive with one part solvent by volume. Stir thoroughly until this mixture achieves a syrup-like constituency.
Step 2 Cut paper liner to fit the upper gum line. See FIG. 1.
Step 3 Cut paper liner to fit the lower gum line. See FIG. 2.
Step 4 Apply a thin and even layer of the mixture made during Step 1 to both sides of the paper liner cut to fit the upper gum line. See FIG. 1.
Step 5 Insert the mixture coated liner from Step 4 into the plate of the upper denture. See FIG. 3.
Step 6 Mount the plate of the upper denture on the upper gum line.
Step 7 Strongly press the plate of the upper denture into the upper gum line with hands.
Step 8 Bite down firmly in order to press the plate of the upper denture into the upper gum line with jaws. This will complete the seal between the upper gum line, mixture coated upper gum line liner, and the plate of the upper denture.
Step 9 Apply a thin and even layer of the mixture made during Step 1 to both sides of the paper liner cut to fit the lower gum line. See FIG. 2.
Step 10 Insert the mixture coated liner from Step 9 into the plate of the lower denture See FIG. 4.
Step 11 Mount the plate of the lower denture on the lower gum line
Step 12 Strongly press the plate of the lower denture into the lower gum line with hands
Step 13 Bite down firmly in order to press the plate of the lower denture into the lower gum line with jaws. This will complete the seal between the lower gum line, mixture coated lower gum line liner, and the late of the lower denture.
